(19) United States
(12) Patent Application Publication
(10) Pub. No.: US 2008/0133609 A1
(43) Pub. Date: Jun. 5, 2008

(54) OBJECT-BASED STORAGE SYSTEM FOR DEFFERRING ELIMINATION OF SHARED FILE AND METHOD THEREOF

(75) Inventors: Sang Min LEE, Daejeon (KR); Hong Yeon KIM, Daejeon (KR); June KIM, Daejeon (KR); Myung Joon KIM, Daejeon (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejeon (KR)

(21) Appl. No.: 11/948,939

(22) Filed: Nov. 30, 2007

(30) Foreign Application Priority Data
Dec. 1, 2006 (KR) 10-2006-0120452
Jul. 27, 2007 (KR) 10-2007-0075545

(51) Int. Cl. G06F 17/30

(52) U.S. Cl. 707/200; 707/E17.005

(57) ABSTRACT

An object-based storage system for deferring elimination of a shared file includes a user file manager and a metadata management server, such that even if an inode shared by a plurality of user file managers connected over a network is eliminated by one of the user file managers, the elimination of the inode is deferred until the use of the inode of another user is completed. When a file elimination request of the user is received, the user file manager sends a request message for transferring an elimination inode corresponding to the file to a temporary directory. The metadata management server receives the request message, and sends a message for transferring an object of the elimination inode to the temporary directory to at least one user file manager connected with the user file manager over the network. Accordingly, every user file manager can use the object-based storage system without considering error processing for an eliminated inode.

### CROSS-REFERENCE TO RELATED APPLICATIONS

This application claims the priority of Korean Patent Application No. 10-2007-75545, filed on Jul. 27, 2007 and Korean Patent Application No. 10-2006-0120452, filed on Dec. 1, 2006 in the Korean Intellectual Property Office, the disclosure of which is incorporated herein by reference.

### BACKGROUND OF THE INVENTION

1. Field of the Invention

The present invention relates to an object-based storage system for deferring elimination of a shared file and a method thereof, and more particularly, to an object-based storage system for deferring elimination of a shared file, which is configured such that even if an inode shared by a plurality of user file managers connected over a network is eliminated by one user file manager, another user file manager using the inode can still use the inode until operation is completed, and a method thereof.

This work was supported by the IT R&D program of MIC/IITA [Project No. 2005-S-405-02, Project Title: A development of the Next Generation Internet Server Technology].

2. Description of the Related Art

An object-based storage device (OSD) is a technology that has emerged as a substitute for a block-based storage. The object-based storage device is an intelligent storage that executes generation of metadata by itself, whereas a server group performs generation of metadata, which is essential for file search of an existing block-based storage. For example, in the case of the block-based storage, metadata describing a physical location of data is generated from an application program such as a database or a file system operated at a server. However, the object-based storage itself has basic functions necessary for storage operation such as a file system or metadata management, so that load of a server is reduced, a data access speed is improved, and flexibility of supporting different types of platforms can be provided.

However, the existing object-based storage system has the following limitations. If an inode being used by a plurality of clients distributed over a network is eliminated by one client, a metadata management server eliminates the shared inode, and sends an error message to other clients. Thus, another user process using the eliminated inode must directly handle error processing. Also, if the error processing is not accurately performed, user service of a client system cannot be properly provided.

### SUMMARY OF THE INVENTION

An aspect of the present invention provides an object-based storage system for deferring elimination of a shared file, which is configured such that even if an inode shared by a plurality of user file managers connected over a network is eliminated by one user file manager, another user file manager using the inode can still use the inode until operation is completed, and a method thereof.

According to an aspect of the present invention, there is provided an object-based storage system for deferring elimination of a shared file including: one or more user file managers connected over a network, wherein when a user's request for eliminating a file is received, the user file manager sends a request message for transferring an elimination inode corresponding to the file to a temporary directory; and a metadata management server transferring and storing the elimination inode in the temporary directory according to the sent request message, sending a message for transferring an object of the elimination inode to the temporary directory to all other user file managers, which are connected with the user file manager over the network and are using the elimination inode, and eliminating the elimination inode stored in the temporary directory when all the user file managers connected over the network complete the use of the elimination inode.

The user file manager may include: an inode elimination change processor changing the request for eliminating a file into a request for transferring the elimination inode corresponding to the file; and an inode transfer routine processor receiving a message for transferring an object of the elimination inode from the metadata management server, and transferring the object of the elimination inode to the temporary directory.

The metadata management server may include: a metadata manager transferring the inode to the temporary directory when receiving the request message from the user file manager; and a user tracking manager tracking and managing the user file managers using the elimination inode.

According to another aspect of the present invention, there is provided a method for deferring elimination of a shared file in an object-based storage system having one or more user file managers connected over a network, including: changing an elimination request for a shared inode to an inode transfer request; sending the changed inode transfer request to a metadata management server; sending a message for transferring an object of the inode to a temporary directory to all other user file managers that are connected with the user file manager over the network and are using the inode; and eliminating the inode when all the user file managers connected over the network complete the use of the inode.

The sending of the changed inode transfer request to the metadata management server may include transferring, at the metadata management server, the inode to the temporary directory when the changed inode transfer request is received.

The sending of the message for transferring the object of the inode to the temporary directory may include receiving, at the user file manager, the message and transferring the object of the inode to the temporary directory, and sending a completion message to the metadata management server after the object of the inode is transferred to the temporary directory.

The eliminating of the inode may include sending, at the user file manager connected over the network, a message for informing the metadata management server that the use of the inode is completed, and sending, at the metadata management server, an inode object elimination message to the user file manager when all of the user file managers connected over the network complete the use of the inode object.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram showing a configuration of an object-based storage system;

FIG. 2 is a block diagram showing a configuration of a user file manager;

FIG. 3 is a block diagram showing a configuration of a user file manager and a metadata management server according to an embodiment of the present invention;

FIG. 4 is a view for a method for deferring elimination of a shared file in an object-based storage system according to an embodiment of the present invention;

FIG. 5 is a flowchart of a process of processing an inode read operation according to an embodiment of the present invention;

FIG. 6 is a flowchart of a process of eliminating an inode according to an embodiment of the present invention; and

FIG. 7 is a flowchart of a process of processing an inode elimination request into an inode transfer request according to an embodiment of the present invention.

### DETAILED DESCRIPTION OF THE PREFERRED EMBODIMENT

Exemplary embodiments of the present invention that would be easily embodied by those of ordinary skill in the art will now be described in detail with reference to the accompanying drawings. However, in detailed description of operational principle according to the exemplary embodiments, well-known functions, well-known structures will not be described in detail to avoid ambiguous interpretation of the present invention.

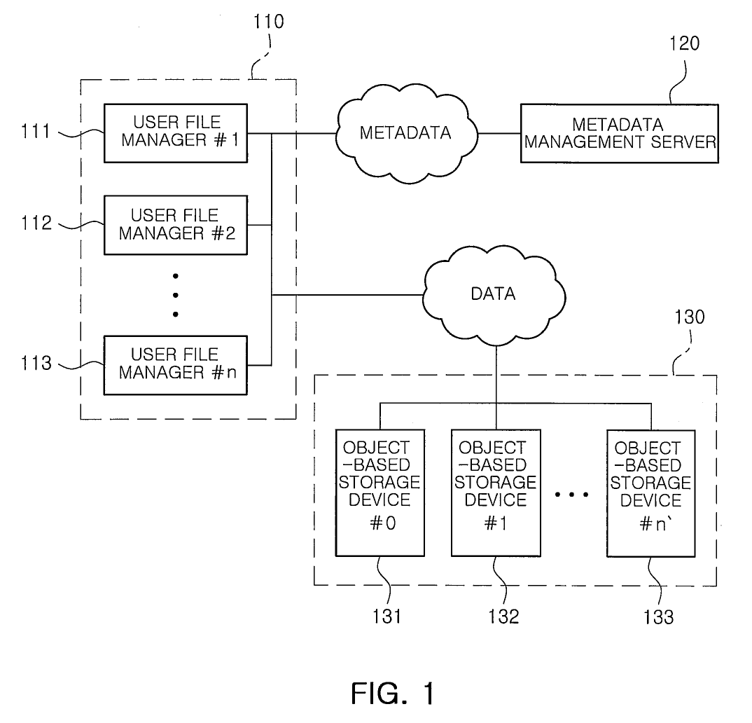

FIG. 1 is a block diagram showing a configuration of an object-based storage system.

In general, the object-based storage system includes one or more user file managers 111, 112 and 113, a metadata management server 120, and one or more object-based storage devices 131, 132 and 133.

The user file managers 111, 112 and 113 are connected over a network. The plurality of user file managers 111, 112 113 (n file user file managers in the drawing) connected over a network share an inode.

Also, when receiving a file-related request from a user, each of the user file managers 111, 112 and 113 requests metadata from a metadata management server 120, and requests actual data of a file from the object-based storage devices 131, 132 and 133.

The metadata management server 120 manages configuration information of a file configured as an object. Also, the metadata management server 120 checks validity of the user file managers 111, 112 and 113, and sends requested metadata, i.e., object configuration information of a file, over a network.

Each of the object-based storage devices 131, 132 and 133 manages an object, and sends object data to the user file managers 111, 112 and 113.

The metadata management server 120 according to an embodiment of the present invention tracks the user file managers 111, 112 and 113 that share an inode, and manages them in a table format. If one user file manager requests elimination of the inode upon user's file elimination request, the metadata management server 120 is requested to transfer the inode shared over the network to a directory that temporarily holes data (hereinafter, the directory will be referred to as a “temporary directory”) instead of immediately eliminating the inode. The metadata management server 120 transfers the inode requested for elimination (hereinafter, this inode will be referred to as an elimination inode) to the temporary directory, and then requests all of the user file managers 111, 112 and 113 using the elimination inode to transfer an elimination-inode object being used thereby to the temporary directory. When the use of the elimination-inode object is terminated, the user file managers 111, 112 and 113 inform the metadata management server 120 that the use of the elimination-inode object is terminated. When the use of the elimination-inode object is completely terminated by the user file managers 111, 112 and 113, the metadata management server 120 eliminates an object of the inode, and eliminates the inode transferred to the temporary directory.

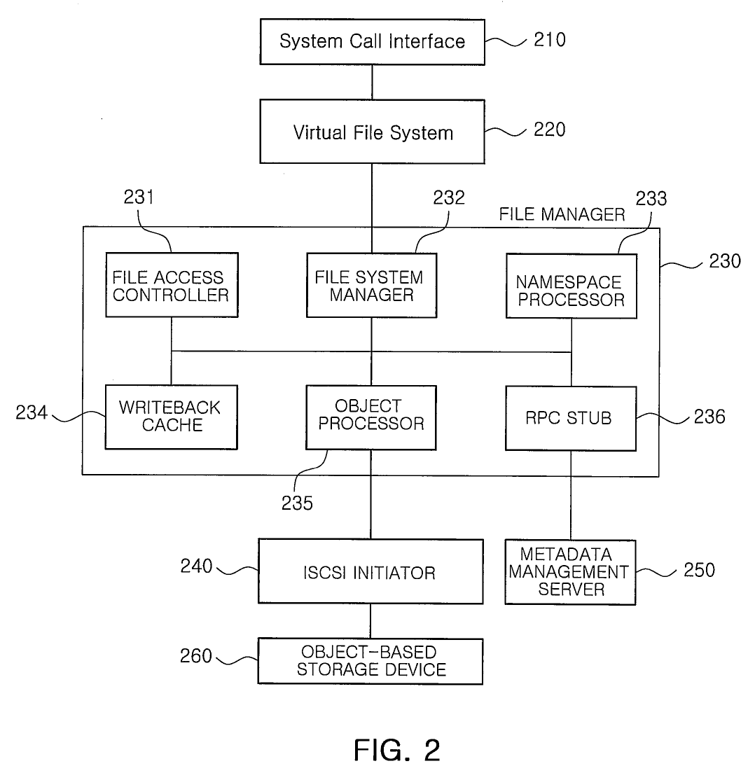

FIG. 2 is a block diagram showing a configuration of a user file manager.

The user file manager 230 includes a file access controller 231, a file system manager 232, a name space processor 233, a writeback cache 234, an object processor 235, and a remote procedure call (RPC) stub 236.

The file system manager 232 serves to register or release file system information to or from a virtual file system 220.

The namespace processor 233 performs namespace processing such as generation, elimination, search and name change of a file or a directory.

The file access controller 231 performs authentication and access control of a user accessing a file.

The writeback cache 234 caches metadata and data of a file. A change of data cached by a user is not applied immediately to a metadata management server of an object-based storage device, but is performed into a writeback cache type. Also, the writeback cache 234 maintains consistency with file data and metadata of files cached in different user file managers.

The object processor 235 provides an object processing function such as generation, deletion, and input/output of an object constituting a file of an object-based storage device 260 through a small computer system interface (SCSI) object-based storage device (OSD) command.

The RPC stub 236 allows access to metadata managed by the metadata management server through RPC protocol.

An iSCSI (Internet SCSI) initiator driver 240 sends an SCSI SOD command created by the object processor 235 to the object-based storage device 260 through iSCSI protocol.

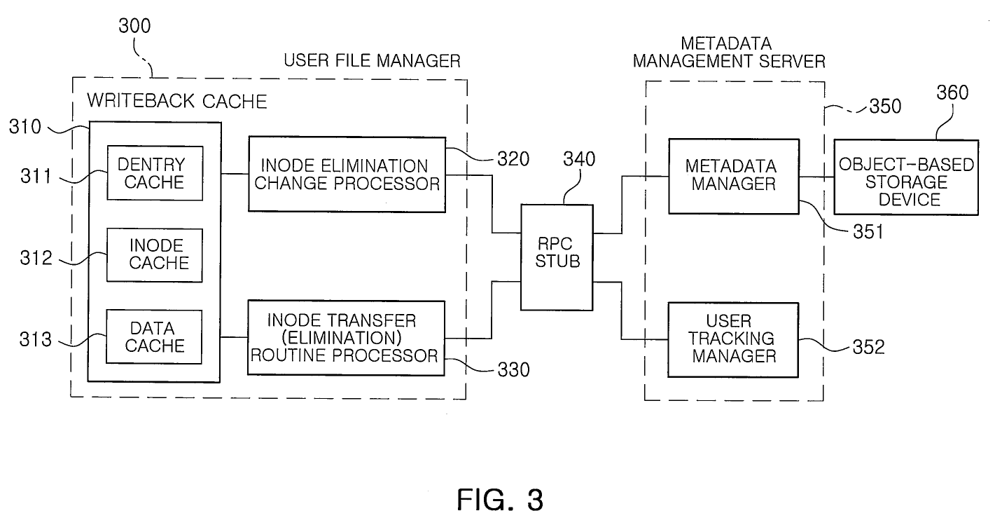

FIG. 2 shows a configuration of an existing file manager of the object-based storage system. Thereafter, a user file manager and a metadata management server according to an embodiment of the present invention will be made with reference to FIG. 3.

FIG. 3 is a block diagram showing a configuration of a user file manager and a metadata management server according to an embodiment of the present invention.

Referring to FIG. 3, a user file manager 300 includes a writeback cache 310, an inode elimination change processor 320, and an inode transfer (elimination) routine processor 330. The metadata management server 350 includes a metadata manager 351 and a user tracking manager 352. The user file manager 300 and the metadata manager 351 access each other through an RPC stub 340.

The writeback cache 310 includes a dentry cache 311 and an inode cache 312 that cache metadata, and a data cache 313 that caches data.

When receiving a file elimination request from a user, the inode elimination change processor 320 changes a request for eliminating an inode of the file to an elimination inode transfer request. The elimination inode transfer request is a message for requesting transfer of an elimination inode to a temporary directory instead of immediately eliminating the inode. That is, the elimination inode transfer request is a message for changing the inode elimination request. When the inode elimination request is changed to the elimination inode transfer request, the elimination inode transfer request is sent to the RPC stub 340 to request the metadata management server 380 to transfer the elimination inode to the temporary directory.

The inode transfer (elimination) routine processor 330 receives from the metadata management server 350, a message for transferring an object of the elimination node, and transfers the object of the elimination inode to the temporary directory. Also, if the inode transfer (elimination) routine processor 330 receives a request for eliminating the object of the elimination inode from the metadata management server 350 in the case where all of user file managers 300 connected over network complete the use of the elimination inode.

The metadata manager 351 manages metadata of the entire object-based storage system.

The user tracking manager 352 tracks which user file managers use which inodes, and manages the tracking result in a table format. Also, when all of the user file managers complete the use of the elimination inode, the user tracking manager 352 requests the metadata mangers to eliminate the elimination inode in the temporary directory. When receiving an inode read request, the user tracking manager 352 registers a user file manger having requested the inode read according to a corresponding inode identifier. Also, when receiving an inode transfer request, the user tracking manager 352 searches whether another user file manager is using an inode to be transferred.

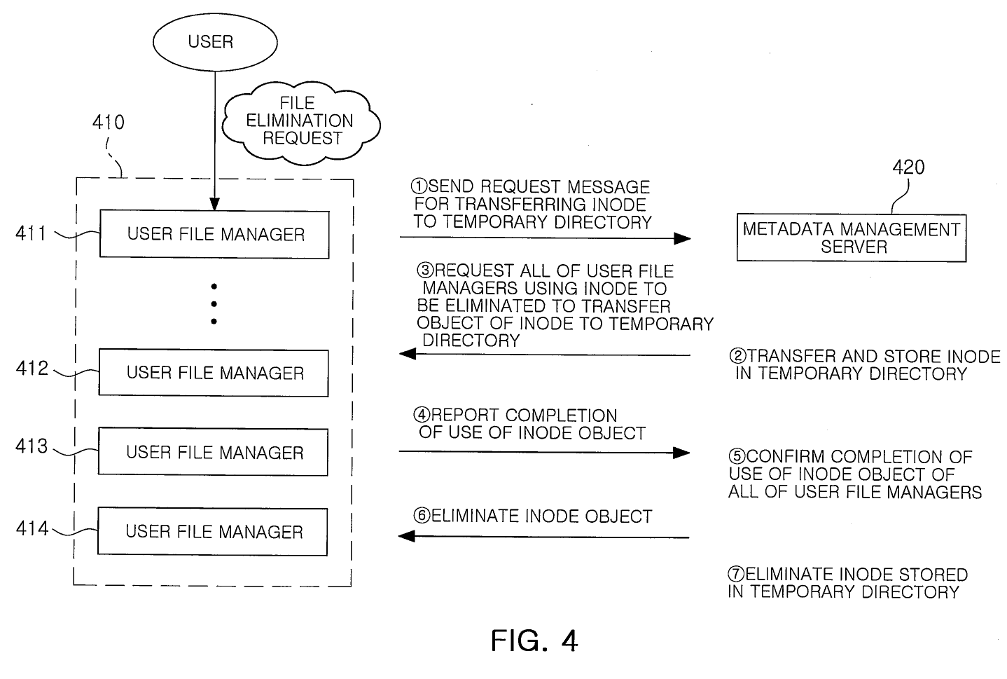

FIG. 4 shows a method for deferring elimination of a shared file in an object-based storage system according to an embodiment of the present invention.

The elimination deferring method in the object-based storage system is made upon user's file elimination request.

When a user makes a file elimination request through a user file manager 411, the user file manager 411 changes an inode elimination request to an inode transfer request, and sends the inode transfer request to a metadata management server 420.

The metadata management server 420 transfers the inode to a temporary directory, and stores it therein. The metadata management server 420 sends every user file manager using the inode to be eliminated a message for requesting transfer of an object of the inode to the temporary directory.

Every user file manager using the inode to be eliminated transfers an inode object to the temporary directory, and sends a completion message indicating the completion of the transfer to the metadata management server 420. Also, when the use of the inode object is completed, the user file manager sends a completion message to the metadata management server.

When confirming completion of the use of the inode object to be eliminated of every user file manager 411, 412, 413 and 414, the metadata management server 420 requests elimination of the inode object and simultaneously eliminates an inode stored in the temporary directory.

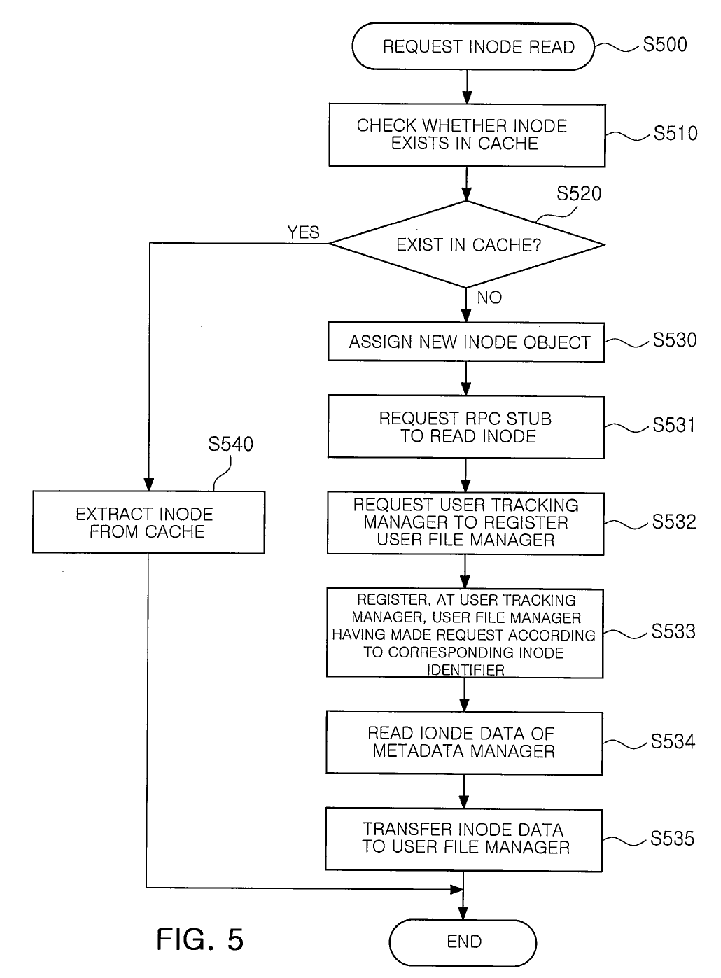

FIG. 5 is a flowchart of a method for processing an inode read operation according to an embodiment of the present invention.

Referring to FIG. 5, when a user makes an inode read request in operation S500, it is checked whether an inode requested for reading exists in a cache of a user file manager in operation S510.

If the inode requested for reading exists in the cache, the corresponding inode is extracted from the cache in operation S540.

In operation S530, if the inode requested for reading does not exist in the cache of the user file manager, one new inode object is assigned in operation S530.

In operation S531, when a new inode is assigned, an RPC stub is requested to read an Inode from the metadata management server.

In operation S532, the metadata management server having received the inode read request requests a user tracking manager to register the user file manager that has made the inode read request.

The user tracking manager registers the user file manager according to a corresponding inode identifier in operation 533.

When the user file manager is registered to the user tracking manager, the metadata manager reads inode data requested for reading from the object-based storage device in operation S534.

In operation S535, the metadata manager transfers inode data to the user file manager.

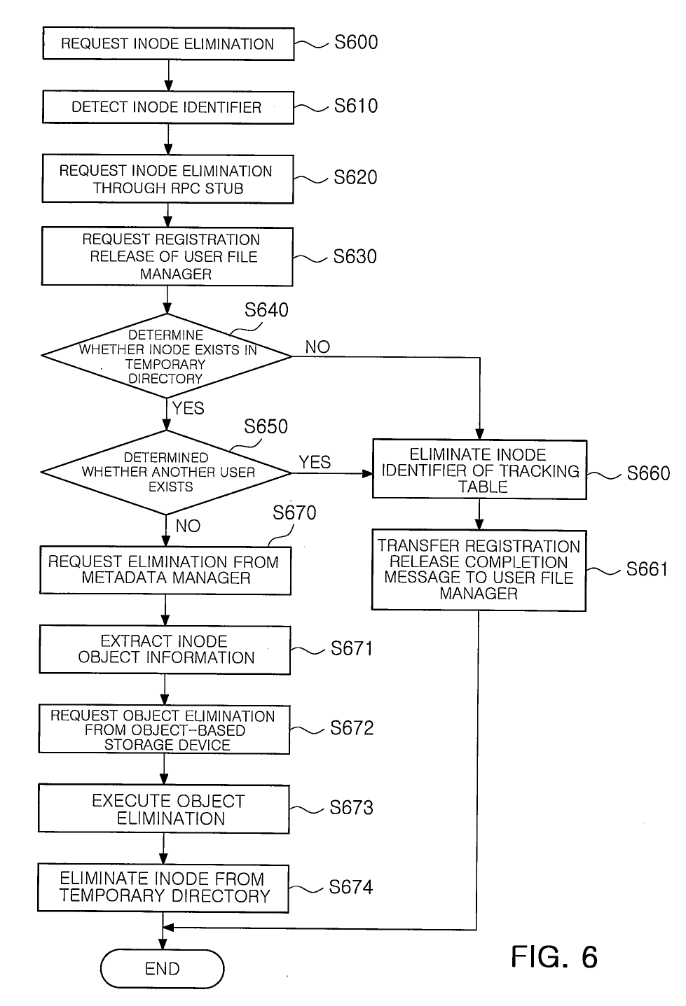

FIG. 6 is a flowchart of a process of eliminating an inode according to an embodiment of the present invention.

When use of an inode object is terminated, a user requests elimination of the inode in operation S600.

In operation S610, when there is an inode elimination request, a user file manager detects an inode identifier of an inode object to be eliminated.

In operation S620, when the inode identifier is detected, an inode elimination request is sent to a metadata management server through an RPC stub.

In operation S630, when receiving the inode elimination request, the metadata management server requests release of registration of the user file manager having requested the inode elimination from a user tracking manager.

In operation S640, the metadata management server having received the inode elimination request determines whether an inode exists in a temporary directory.

In operation S660, if the inode does not exist in the temporary directory, the user tracking manager eliminates a corresponding inode identifier of the user from a tracking table.

In operation S661, when the corresponding inode identifier is eliminated, a registration-release completion message is sent to the user file manager.

In operation S650, if the inode requested for elimination exists in the temporary directory, the metadata management server determines whether another user is using the inode requested for elimination.

If another user is using the inode requested for elimination, the user tracking manager eliminates the corresponding inode identifier in the tracking table in operation S660, and sends a registration-release completion message to the user file manager in operation S661.

When the inode requested for elimination exists in the temporary directory and is not being used by another user, the metadata management server requests the metadata manger to eliminate the inode in the temporary directory in operation S670.

The metadata manger extracts object information of the inode in operation S671. In operation S672, the metadata manager sends an object elimination request message to an object-based storage device that stores and manages the corresponding object. In operation S673, the object-based storage device having received the object elimination request eliminates the corresponding object, and sends a completion message to the metadata manager. When the elimination of the object is completed, the metadata manager eliminates the inode from the temporary directory in operation S674.

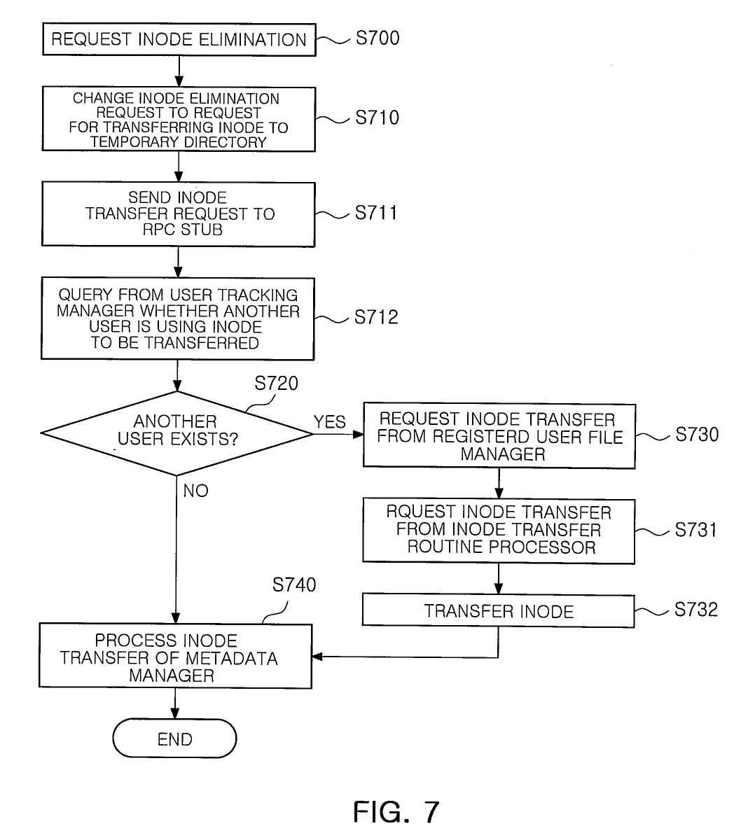

FIG. 7 is a flowchart of a process of processing an inode elimination request into an inode transfer request.

When a user makes an inode elimination request in operation S700, an inode elimination change processor of a user file manager changes an inode elimination request to an inode transfer request in operation S710.

The inode elimination change processor sends the inode transfer request to an RPC stub, and is sent to a metadata management server in operation S711. The metadata management server having received the inode transfer request checks whether another user file manager is using an inode that is to be transferred to a user tracking manager in operation S712.

If another user file manager is not using the corresponding inode, the inode transfer request is sent to a metadata manager in operation S740. If at least one user file manager is using the inode, a transfer request of an inode object is sent to the user file manager registered on a tracking table in operation S730. An RPC stub of the user file manager requests transfer of an inode from an inode transfer routine processor in operation S731.

The inode transfer routine processor transfers an object of the inode to a temporary directory, and then sends a completion message to the metadata management server in operation S732.

After the metadata management server receives a completion message from every user file manager using the inode to be eliminated, the metadata management server performs processing such that the metadata manager transfers the inode to the temporary director in operation S740.

In an object-based storage system for deferring elimination of a shared file, and a method for deferring elimination of a shared file in the same, even if an inode is eliminated by one user management server, inode elimination is deferred until the inode use of another user management server is completed. Accordingly, every user file manager can use the object-based storage system without considering error processing for an eliminated inode.

While the present invention has been shown and described in connection with the exemplary embodiments, it will be apparent to those skilled in the art that modifications and variations can be made without departing from the spirit and scope of the invention as defined by the appended claims.

What is claimed is:

1. An object-based storage system for deferring elimination of a shared file comprising:
one or more user file managers connected over a network, wherein when a user's request for eliminating a file is received, the user file manager sends a request message for transferring an elimination inode corresponding to the file to a temporary directory; and
a metadata management server transferring and storing the elimination inode in the temporary directory according to the sent request message, sending a message for transferring an object of the elimination inode to the temporary directory to all other user file managers, which are connected with the user file manager over the network and are using the elimination inode, and eliminating the elimination inode stored in the temporary directory when all the user file managers connected over the network complete the use of the elimination inode.

2. The system of claim 1, wherein the user file manager comprises:
an inode elimination change processor changing the request for eliminating a file into a request for transferring the elimination inode corresponding to the file; and
an inode transfer routine processor receiving a message for transferring an object of the elimination inode from the metadata management server, and transferring the object of the elimination inode to the temporary directory.

3. The system of claim 2, wherein the metadata management server comprises:
a metadata manager transferring the inode to the temporary directory when receiving the request message from the user file manager; and
a user tracking manager tracking and managing the user file managers using the elimination inode.

4. The system of claim 3, wherein the user file manager connected over the network informs the metadata management server that use of the object of the elimination inode is completed.

5. The system of claim 4, wherein when all of the user file managers connected over the network completes the use of the object of the elimination inode, the metadata management server requests all of the user file managers to eliminate the object of the elimination inode transferred to the temporary directory.

6. The system of claim 3, wherein the user file manager connected over the network transfers a completion message to the metadata management server after the object of the elimination inode is transferred to the temporary directory.

7. The system of claim 6, wherein the metadata management server transfers the elimination inode to the temporary directory after the completion message is received from all of the user file managers using the elimination inode.

8. The system of claim 1, wherein the metadata management server tracks and manages user file managers using each inode in a table format.

9. A method for deferring elimination of a shared file in an object-based storage system having one or more user file managers connected over a network, the method comprising:
changing an elimination request for a shared inode to an inode transfer request;
sending the changed inode transfer request to a metadata management server;
sending a message for transferring an object of the inode to a temporary directory to all other user file managers that are connected with the user file manager over the network and are using the inode; and
eliminating the inode when all the user file managers connected over the network complete the use of the inode.

10. The method of claim 9, wherein the sending of the changed inode transfer request to the metadata management server comprises transferring, at the metadata management server, the inode to the temporary directory when the changed inode transfer request is received.

11. The method of claim 9, wherein the sending of the message for transferring the object of the inode to the temporary directory comprises receiving, at the user file manager, the message and transferring the object of the inode to the temporary directory.

12. The method of claim 11, wherein the sending of the message for transferring the object of the inode to the temporary directory comprises sending, at the user file manager, a completion message to the metadata management server after the object of the inode is transferred to the temporary directory.

13. The method of claim 9, wherein the eliminating of the inode comprises sending, at the user file manager connected over the network, a message for informing the metadata management server that the use of the inode is completed.

14. The method of claim 12, wherein the eliminating of the inode comprises sending, at the metadata management server, an inode object elimination message to the user file manager when all of the user file managers connected over the network complete the use of the inode object.
